(19) United States
(12) Patent Application Publication
(10) Pub. No.: US 2019/0375661 A1
(43) Pub. Date: Dec. 12, 2019

(54) Helical Bed Biofilm Reactor for Wastewater Treatment

(71) Applicant: Jiangnan University, Wuxi (CN)

(72) Inventors: Zhiyong ZHENG, Wuxi (CN); Zifan WANG, Wuxi (CN); He LIU, Wuxi (CN)

(21) Appl. No.: 16/546,490

(22) Filed: Aug. 21, 2019

(30) Foreign Application Priority Data
Jan. 29, 2019 (CN) 201910085134.0

(51) Int. Cl. C02F 3/10; C02F 3/12; C02F 3/20

(52) U.S. Cl. CPC C02F 3/109; C02F 3/20; C02F 3/1236

(57) ABSTRACT

The disclosure herein relates to a helical bed biofilm reactor for wastewater treatment, and belongs to the fields of environment engineering and chemical engineering. The helical bed biofilm reactor comprises a reaction vessel, a draft tube, helical screen meshes, carriers, a carrier passage, a gas distributor, a gas inlet, a gas outlet, a water inlet, a water outlet and a sludge outlet. By improving the arrangement structure of the carriers and the structure of the helical passage, the helical bed biofilm reactor improves the oxygen transfer rate, the oxygen transfer efficiency and the biological reaction efficiency of a biological treatment process of wastewater, and helps to control the thickness of the biofilm and reduce energy consumption in wastewater treatment.

### TECHNICAL FIELD

The disclosure herein relates to a helical bed biofilm reactor for wastewater treatment, and belongs to the fields of environment engineering and chemical engineering.

### BACKGROUND

Aeration is an indispensable and most energy-intensive operation unit in aerobic biological wastewater treatment process, accounting for 50-80% of the total energy consumption of wastewater treatment plants, and accounting for 1% of the total electricity consumption of some countries. However, in a biological aeration reactor, only 2-10% of oxygen is efficiently taken up and utilized by microorganisms. How to save energy has become an urgent issue of concern for modern biological wastewater treatment. Increase in the oxygen transfer rate, the oxygen transfer efficiency and the microbial reaction efficiency is the main way to solve this problem, and needs to be explored from the perspectives of bioreactors, microbial populations, treatment processes, metabolic reaction mechanisms, and the like. Biofilm process of wastewater mainly uses an immobilized microbial community to form a biofilm to remove dissolvable and colloidal organic pollutants in wastewater. A biofilm reactor is equipment that utilizes a biofilm to efficiently treat wastewater and is widely used in environment engineering. Aiming at different wastewater characteristics and treatment scales, researchers have developed a variety of aerobic biofilm reactors to improve wastewater treatment efficiency and save energy. The main forms of biofilm reactors are integrated fixed-biofilm activated sludge (IFAS), moving bed biofilm reactors (MBBR), membrane biofilm reactors (MBfR), biofilters (common biofilter, high load biofilter and tower biofilter), biological rotating discs, biological contact oxidation process, biological fluidized beds, granular sludge process, etc., which have been successfully applied to the wastewater treatment process.

The biological contact oxidation process is developed on the basis of the biofilm process. Wastewater is in contact with a biofilm and is treated under the action of microorganisms. The biological contact oxidation process adopts an aeration method to provide dissolved oxygen for microorganisms and apply the stirring and mixing effects. Carriers are put in an aeration tank for the microorganisms to adhere and grow, and the biological contact oxidation process is a biological treatment method between the activated sludge process and the biofilter process. The problems of the biological contact oxidation process are mainly that the biofilm between the carriers in the tank sometimes has a clogging phenomenon, and the carriers are easily aged and difficult to be removed and washed.

A moving bed biofilm reactor is a biofilm treatment method that emerged in the late 1980s. The moving bed biofilm reactor adopts the advantages of both the conventional fluidized bed and the biological contact oxidation process, and becomes a relatively efficient wastewater treatment method by utilizing suspended carriers. The suspended carriers are made of a specially treated polypropylene material, and the carriers have a density of 0.95-1.00 g/cm³ and a large specific surface area (160-450 m²/m³). A biofilm easily grows on the surfaces of the carriers, and the structure of the carriers is designed so that the carriers do not agglomerate or block when in use. However, the problem in the moving bed biofilm reactor is mainly: the carriers in the reactor are in a fluidized state by the lifting action of aeration and water flow, but in actual operation, local accumulation of carriers and insufficient liquid mixing are often caused by uneven gas distribution throughout the pool. The moving bed bioreactor is generally 2-6 meters deep, and the oxygen transfer efficiency per meter depth is higher than that of an activated sludge reaction vessel, but is still relatively low, about 1.0-2.5%/m.

### SUMMARY

The disclosure provides a helical bed biofilm reactor for wastewater treatment, which considers the macro-mixing and micro-mixing processes, increases the rate and efficiency of gas-liquid oxygen transfer, controls the thickness of a biofilm, and reduces the head loss and energy consumption in the vertical direction. The helical bed biofilm reactor uses jet air as the sole source of power to drive liquid to circulate, reduces the bubble size, increases the volumetric oxygen transfer coefficient and the oxygen uptake rate, promotes the bioreaction efficiency, and prevents the detached biomass from blocking a fluid passage.

The present disclosure is directed to provide a helical bed biofilm reactor for wastewater treatment, comprising a vessel, a draft tube, carriers and a carrier passage. A gas outlet is arranged at the top of the vessel, a sludge outlet is arranged at the bottom of the vessel, a water outlet and a water inlet are arranged on the side wall of the vessel, and the water outlet is positioned above the water inlet. The draft tube is positioned inside the vessel and is arranged coaxially with the vessel, the height of the draft tube is smaller than the height of the vessel, and the upper part of the draft tube gets through the water inlet. The carrier passage is positioned inside the vessel and is arranged helically along the outside of the draft tube. The carrier passage is composed of upper and lower helical screen meshes, and the two side edges of each layer of the helical screen mesh are respectively fixed to the side wall of the vessel and the outer wall of the draft tube. The carrier passage is internally filled with the carriers. The passage between adjacent carrier passages forms a no-load passage.

In an example of the present disclosure, the bottom of the vessel is a conical bottom.

In an example of the present disclosure, the cone angle at the bottom of the vessel is 90-150°.

In an example of the present disclosure, the vessel is provided with carrier inlets and carrier outlets. The carrier inlet is arranged at the upper part of the outer side of the reaction vessel, and horizontally connects with the highest point of the helical screen meshes, so that the carriers can be filled into the carrier passage composed of the upper and lower helical screen meshes. The carrier outlet is positioned at the lower part of the outer side of the reaction vessel, connects with the lowest point of the helical screen meshes in the horizontal direction, and is used for discharging the carriers. Flat screen meshes are respectively arranged at the carrier inlet and the carrier outlet, and the flat screen meshes are connected and fixed to the two upper and lower helical screen meshes of the carrier passage.

In an example of the present disclosure, the carrier inlet and the carrier outlet are respectively led out to the outside of the reaction vessel.

In an example of the present disclosure, the shapes of the carrier inlet and the carrier outlet are rectangles, and the height of the rectangle is equal to the vertical height of the side passage of the carriers. The carrier inlet and the carrier outlet adopt a square vertical hanging cover hubbed flange manhole on the outside of the vessel.

In an example of the present disclosure, the carriers are composed of carrier shells and inner core carriers. The inner core carriers are arranged inside the carrier shells and are not fixed to the carrier shells. The carrier shells are mesh-like spheres. The inner core carriers can be carriers with brush-like protrusions on the surfaces or polygonal carriers with through holes inside. When the reactor is in operation, the inner core carriers tumble in the spherical carriers under hydraulic action.

In an example of the present disclosure, the mesh aperture of the carrier shells is 18-25 mm.

In an example of the present disclosure, the structure of the inner core carriers is honeycomb, or spongy, or foam-like, or brush-like on the surfaces, and may be similar to carriers of a moving bed biofilm reactor (MBBR) or a combination thereof.

In an example of the present disclosure, the diameter of the carrier shells is 50-100 mm, the size of the inner core carriers is smaller than the diameter of the carrier shells but larger than the mesh aperture of the carrier shells, so that the inner core carriers cannot leak out of the carrier shells.

In an example of the present disclosure, the material of the inner core carriers can be plastic, sponge or nylon fiber or the like.

In an example of the present disclosure, the inner core carriers have a material density of 1.00-1.20 g/cm³ and tumble in the carrier shells under hydraulic action.

In an example of the present disclosure, the pitch of the helical screen meshes is equal, and the number of the helical screen meshes is an even number.

In an example of the present disclosure, the spacing of the adjacent helical screen meshes is the same or different. The spacing of the adjacent helical screen meshes is 5%-50% of the pitch of the helical screen meshes.

In an example of the present disclosure, the ratio of the distance between the lowest point of the helical screen meshes in the vertical direction and the bottom of the draft tube to the inner diameter of the reaction vessel is 0.1-0.6; and the ratio of the distance between the highest point of the helical screen meshes in the vertical direction and the top of the draft tube to the inner diameter of the reaction vessel is 0.1-0.5.

In an example of the present disclosure, the ratio of the distance between the bottom of the draft tube and the upper edge of the bottom head of the vessel to the inner diameter of the reaction vessel is 0-0.3.

In an example of the present disclosure, the height-to-diameter ratio of the cylinder part of the vessel where a gas-liquid mixing zone is positioned in the inner space of the vessel is (2:1)-(6:1), the inner diameter of the vessel of a gas-liquid separation zone is not less than the inner diameter of the vessel where the gas-liquid mixing zone is positioned, and the ratio of the cross-sectional area of an riser section of the reaction vessel to the cross-sectional area of a downcomer section is (1:0.3)-(1:1).

In an example of the present disclosure, the helical surface of the helical screen meshes is a positive helical surface, or an inwardly inclined helical surface, or an outwardly inclined helical surface.

In an example of the present disclosure, the free area ratio of the helical screen meshes is 60%-90%, and the hole size of the helical screen meshes is smaller than the diameter of the carriers so that the carriers cannot leak out of the mesh holes.

In an example of the present disclosure, the hole diameter of the helical screen meshes is 10-50 mm.

In an example of the present disclosure, the material of the helical screen meshes is a strong and corrosion resistant material including but not limited to, plastic, nylon, composite non-metallic materials or lightweight metal alloy materials.

In an example of the present disclosure, a gas distributor is arranged below the draft tube.

In an example of the present disclosure, the gas distributor is arranged right below the carrier passage. The gas distributor is an looped tube gas distributor, or a plurality of nozzles arranged in the circumferential direction, or an aeration tube containing a plurality of microporous membrane, or an aerator containing a plurality of micropores. A plurality of gas outlet holes are uniformly distributed along the circumferential direction at the top of the looped tube, and the gas outlet holes are upward and face the annular gap-shaped riser section. 1-3 downward sludge outlets are arranged at the bottom of the looped tube to prevent sludge from clogging the gas distributor when the equipment is stopped.

In an example of the present disclosure, the biofilm reactor is an atmospheric pressure vessel, or a pressure vessel.

The present disclosure is further directed to provide application of the helical bed biofilm reactor.

In an example of the present disclosure, the application comprises wastewater treatment.

The present disclosure further claims to protect equipment comprising the helical bed biofilm reactor, or equipment connected with the helical bed biofilm reactor consistent with the present disclosure.

Beneficial effects: The present disclosure has the following advantages compared with the prior art:

(1) In the helical bed biofilm reactor consistent with the present disclosure, the helical passage on one side is loaded with carriers, bubbles are broken when passing through the gaps of the carriers, so bubble coalescence is prevented, and the bubble size is controlled within a certain range (millimeter scale). The specific surface area of the gas-liquid phases is effectively improved, and the bubbles have a higher gas-liquid flow rate difference, which is favorable for the gas-liquid mass transfer rate. The no-load helical passage on the other side can reduce liquid phase cycle time and vertical head loss, accelerate gas-liquid flow and enhance mixing.

(2) A higher height-to-diameter ratio of a reaction vessel and a helical passage are advantageous for prolonging the gas-liquid-solid contact time. Compared to the carrier-free airlift reactor, the oxygen transfer rate (OTR) of the helical bed biofilm reactor can be increased by 40-85% and the oxygen transfer efficiency (OTE) is increased by 35-75%.

(3) The rising gas-liquid flow interacts with the inner core carriers to keep the inner core carriers in a state of micro-motion, and the thickness of the biofilm can be controlled to prevent the carrier passage from being blocked by the detached biofilm. Compared with a common fixed bed biofilm reactor, the present disclosure provides an unblocked helically rising no-load passage. On the one hand, the head loss of the circulating liquid flow is reduced, and the gas-liquid flow circulation rate is ensured. On the other hand, the gas-liquid flow with a higher rate flushes the biofilm in the adjacent carrier passage, further preventing the biofilm from being too thick and clogging the bed.

(4) The present disclosure provides a biofilm carrier inlet and a biofilm carrier outlet convenient for replacement. The spherical composite carriers can be introduced into the carrier passage composed of two helical screen meshes from the outside of the reactor through the carrier inlet, or be conveniently discharged from the carrier outlet.

(5) Compared with the moving bed biofilm reactor, the carriers of the helical bed biofilm reactor are more reasonably arranged in the space of the reaction vessel, and the disadvantages that the position of the carriers in the moving bed biofilm reactor is difficult to control and partial accumulation is likely to occur are solved.

### BRIEF DESCRIPTION OF FIGURES

FIG. 1 is a schematic view showing the structure of the helical bed biofilm reactor consistent with the present disclosure.

FIG. 2 is a cross-sectional view of the helical bed biofilm reactor consistent with the present disclosure.

FIG. 3 is a schematic view showing the structure of the inside of the helical bed biofilm reactor (not including the reaction vessel) consistent with the present disclosure.

FIG. 4 is a schematic view showing the proportional relationship of different structures of the helical bed biofilm reactor.

FIG. 5 is a three-dimensional structural view of a carrier used in the helical bed biofilm reactor consistent with the present disclosure, wherein (a) is a built-in brush-like carrier, and (b) is a built-in honeycomb carrier.

FIG. 6 is a schematic view showing the structure of another example of the helical bed biofilm reactor consistent with the present disclosure.

FIG. 7 is a comparison of volumetric oxygen transfer coefficient (k_{L}α), oxygen uptake rate (OUR) and oxygen transfer efficiency (OTE) of different reactors.

Among them: 1 is a vessel; 2 is a carrier passage; 3 is an no-load passage; 4 is a carrier; 11 is a gas outlet; 12 is a water inlet; 13 is a water outlet; 14 is a draft tube; 15 is a sludge outlet; 16 is a gas distributor; 17 is a carrier inlet; 18 is a carrier outlet; 19 is a gas-liquid separation zone; 21 is a flat screen mesh; 22 is a helical screen mesh; 23 is an upper edge line; 24 is a lower edge line; 25 is an inner edge line; 26 is an outer edge line; 41 is a carrier shell; and 42 is an inner core carrier.

### DETAILED DESCRIPTION

The specific examples of the present disclosure are further described in detail below with reference to the drawings and examples. The following examples are intended to illustrate the present disclosure but not to limit the scope of the present disclosure.

In the biological reaction process, when the dissolved oxygen concentration C_{L} value is constant, OTR=OUR is established, where OTR is the oxygen transfer rate (mg/L·h), and OUR is the oxygen uptake rate (mg/L·h).

Reference paper for measuring method of OUR: Biotechnology Advances, 2009, 27:153-176.

k_{L}α=OTR/(C_{L}*−C_{L});

OTE=(O_{2,in}−O_{2,out})/O_{2,in};

where k_{L}α is the volumetric oxygen transfer coefficient (h⁻¹); C_{L}* is the saturated dissolved oxygen value (mg/L); C_{L} is the actual dissolved oxygen value (mg/L); OTE is the oxygen transfer efficiency (%); O_{2,in} is the oxygen concentration (%,v) in the inlet gas; O_{2,out} is the oxygen concentration (%,v) in the outlet gas. The dissolved oxygen concentration C_{L} is measured by a dissolved oxygen electrode, and the oxygen concentration in the inlet and outlet gases is measured by an exhaust gas analyzer.

### EXAMPLE 1

### Helical Bed Biofilm Reactor

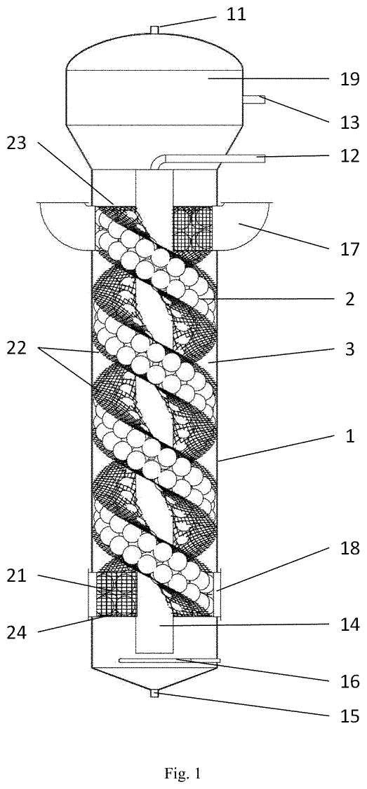

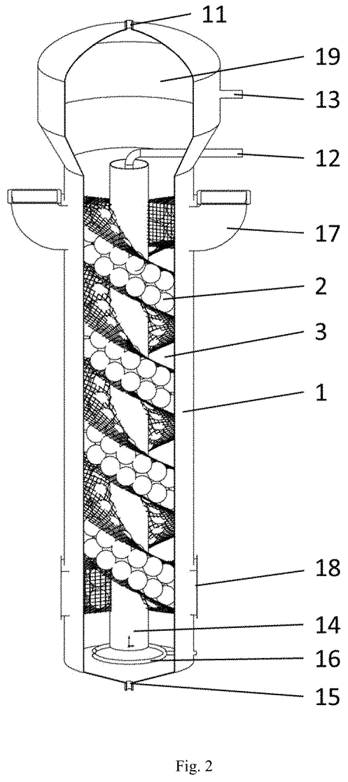

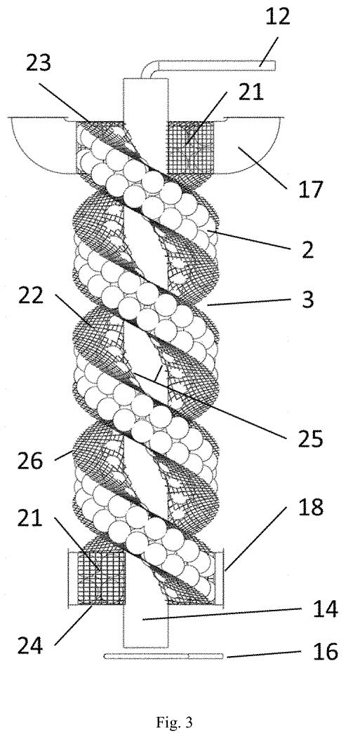

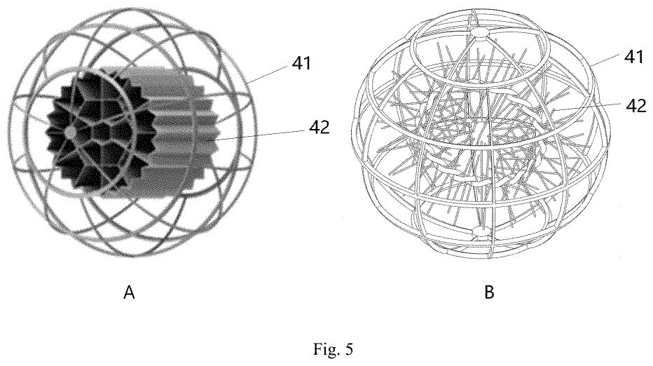

As shown in FIGS. 1-5, a helical bed biofilm reactor for wastewater treatment comprises a vessel 1, a draft tube 14, a no-load passage 3 and a carrier passage 2. The inner space of the vessel 1 comprises a gas-liquid mixing zone and a gas-liquid separation zone 19 positioned above the gas-liquid mixing zone; the gas-liquid separation zone 19 refers to an area above the liquid level in the reactor, including the area where the foam is. The gas-liquid mixing zone is an area below the liquid level. A gas outlet 11 is arranged at the top of the vessel 1, a sludge outlet 15 is arranged at the bottom of the vessel, a water outlet 13 and a water inlet 12 are arranged on the side wall of the vessel 1, the water inlet 12 is positioned close to the top of the draft tube, and the water outlet 13 is positioned above the water inlet 12. The draft tube 14 is arranged coaxially with the vessel 1. The inner space and the outer space of the draft tube 14 respectively form a cylindrical passage and an annular gap-shaped passage. During the operation of the reactor, the reaction liquid forms a downcomer section in the cylindrical passage inside the draft tube 14, and forms a riser section in the annular gap passage outside the draft tube. A gas distributor 16 is arranged on the outside of the lower side of the draft tube 14, and the inside of the upper side of the draft tube 14 communicates with the water inlet 12. The carrier passage 2 is positioned in the vessel 1 and is arranged helically along the outside of the draft tube 14, the upper layer and the lower layer are helical screen meshes 22, and the interior is filled with carriers 4. The helical screen meshes 22 are respectively fixed to the outer wall of the draft tube 14 and the side wall of the vessel 1. The passage between the adjacent carrier passages 2 forms a no-load passage 3. The upper and lower ends of the no-load passage 3 are open ports, allowing gas-liquid flow and suspended cells to flow freely. The vessel 1 is provided with a carrier inlet 17 and a carrier outlet 18. The carrier inlet 17 is arranged at the upper part of the outer side of the vessel 1, and connects with the horizontal highest point of the helical screen meshes 22, so that the carriers 4 can be filled into the carrier passage 2 composed of the upper and lower helical screen meshes 22. The carrier outlet 18 is positioned at the lower part of the outer side of the vessel 1, connects with the lowest point of the horizontal position of the helical screen meshes 22, and is used for discharging the carriers.

The working principle of the helical bed biofilm reactor is that the carrier passage 2 is filled with the carriers 4 before the reactor starts to operate, so that the biofilm grew up when the reactor starts to operate. When the reactor operates, reaction liquid flows in from the water inlet 12 at a certain flow rate while flowing out from the water outlet 13 at the same flow rate, thereby maintaining the volume of the reaction liquid in the reactor constant. The draft tube 14 divides the gas-liquid mixing zone into a cylindrical downcomer section and an annular gap-shaped riser section. The area between the draft tube 14 and the vessel 1 is the annular gap-shaped riser section for bubbles, wastewater and suspended activated sludge to move from bottom to top. The area in the draft tube 14 is the downcomer section for the wastewater and the suspended activated sludge to move from top to bottom. During the treatment of the wastewater, the gas distributor 16 introduces air into the annular gap-shaped riser section. The carrier passage 2 forms a helical bed alternately filled with the carriers 4 in the riser section. The microorganisms in the reaction system adhere to and grow on the surfaces of the helical screen meshes 22 and the carriers 4 to form biofilm. When a part of the rising gas and liquid flow passes through the carrier passage 2, the bubbles collide with the carriers 4 to be broken, forming small bubbles. The other part of the gas and liquid flow helically rises along the no-load passage 3. Most of the bubbles escape from the liquid level in the gas-liquid separation zone 19, and a small amount of small bubbles enter the downcomer section (within the draft tube 14) along with the liquid flow, forming a circulating flow.

### EXAMPLE 2

### Helical Bed Biofilm Reactor

On the basis of Example 1, improvement of the details of the reactor involves:

The upper and lower ends of the carrier passage 2 respectively connected with the carrier inlet 17 and the carrier outlet 18. Flat screen meshes 21 are respectively arranged at the carrier inlet 17 and the carrier outlet 18, and the flat screen meshes 21 are connected and fixed to the two upper and lower helical screen meshes 22 of the carrier passage 2. Further, the carrier inlet 17 and the carrier outlet 18 are respectively led out to the outside of the vessel. The carrier inlet 17 and the carrier outlet 18 may be in the shape of a rectangle or other customary shapes. The carrier inlet 17 and the carrier outlet 18 adopt a square vertical hanging cover hubbed flange manhole on the outside of the vessel.

The carriers 4 are composed of carrier shells 41 and inner core carriers 42. The inner core carriers 42 are arranged inside the carrier shells 41 and are not fixed to the carrier shells 41. The carrier shells are mesh-like spheres. The inner core carriers 42 can be carriers with brush-like protrusions on the surfaces or polygonal carriers with through holes inside. When the reactor is in operation, the inner core carriers 42 tumble in the carrier shells 41 under hydraulic action.

Further, the structure of the inner core carriers 42 is honeycomb, or spongy, or foam-like, or brush-like on the surfaces, and may be similar to carriers of a moving bed biofilm reactor (MBBR) or a combination thereof. The diameter of the carriers 4 is 50-100 mm, the size of the inner core carriers 42 is smaller than the diameter of the carrier shells 41 but larger than the pore diameter of the carrier shells 41, so that the inner core carriers cannot leak out of the carrier shells. The material of the inner core carriers can be plastic, sponge or nylon fiber or the like. The inner core carriers have a material density of 1.00-1.20 g/cm³, tumble in the carrier shells under hydraulic action, and control the thickness of the biofilm.

The bottom of the vessel 1 is a conical bottom to facilitate sludge discharge. Further, the included angle of the bottom of the vessel 1 is 120°.

The pitch of the helical screen meshes 22 in the vessel can be equal, and the number of the helical screen meshes is an even number.

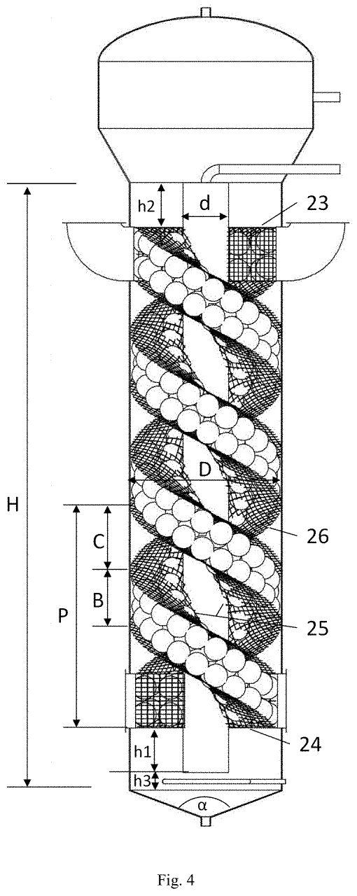

The spacing (B or C) of the adjacent helical screen meshes 22 can be the same or different (FIG. 4). The spacing of the adjacent helical screen meshes is 5%-50% of the pitch P of the helical screen meshes 22. The ratio of the distance h1 between the lower edge line 24 (the lowest point in the vertical direction) of the helical screen meshes 22 and the bottom of the draft tube 14 to the inner diameter D of the vessel 1 is 0.1-0.6. The ratio of the distance h2 between the upper edge line 23 (the highest point in the vertical direction) of the helical screen meshes 22 and the top of the draft tube 14 to the inner diameter D of the vessel 1 is 0.1-0.5. The ratio of the distance h3 between the bottom of the draft tube 14 and the upper edge of the bottom head of the vessel 1 to the inner diameter D of the vessel 1 is 0-0.3.

The height-to-diameter ratio (H:D) of the cylinder part of the vessel where a gas-liquid mixing zone is positioned in the inner space of the vessel 1 is (2:1)-(6:1), the inner diameter of the vessel of a gas-liquid separation zone is not less than the inner diameter of the vessel where the gas-liquid mixing zone is positioned, and the ratio of the cross-sectional area of an riser section of the vessel to the cross-sectional area of a downcomer section is (1:0.3)-(1:1).

The carriers 4 are put in from the carrier inlet 17; after the carrier outlet 18 is opened, the carriers 4 can be discharged from the carrier outlet 18. The helical surface of the helical screen meshes 22 is a positive helical surface, or an inwardly inclined helical surface, or an outwardly inclined helical surface. The inwardly inclined helical surface means that the outer edge line 26 of the helical surface is higher than the inner edge line 25, otherwise called outwardly inclined helical surface.

The free area ratio of the helical screen meshes 22 is 60%-90%, and the mesh holes of the helical screen meshes 22 is smaller than the diameter of the carriers 4 so that the carriers 4 cannot leak out of the mesh holes. More specifically, the pore diameter of the helical screen meshes 22 is 10-50 mm. The material of the helical screen meshes is a strong and corrosion resistant material including but not limited to, plastic, nylon or stainless steel.

The draft tube 14 communicates with the water inlet 12 of the vessel 1.

The gas distributor 16 is arranged below an annular gap-shaped riser section. The gas distributor 16 is an looped tube gas distributor, or a plurality of nozzles arranged in the circumferential direction, or an aeration tube containing a plurality of microporous membrane, or an aerator containing a plurality of micropores. A plurality of gas outlet holes are uniformly distributed along the circumferential direction at the top of the looped tube, and the gas outlet holes are upward and face the annular gap-shaped riser section. 1-3 downward sludge outlets are arranged at the bottom of the looped tube to prevent sludge from clogging the gas distributor when the equipment is stopped.

The number of the carrier passages 2 may be two, and the number of the helical screen meshes 22 required to form the carrier passages 2 is four. As shown in FIG. 4, the ratio of the vertical height B of the carrier passages 2 to the inner diameter D of the vessel is 0.5. The ratio of the vertical height C of the no-load passage 3 to the inner diameter D of the vessel 1 is 0.5. The ratio of the pitch P of the helical screen meshes 22 to the inner diameter D of the vessel 1 is 2.

The ratio of the distance h1 between the lower edge line 24 of the helical screen meshes 22 and the bottom of the draft tube 14 to the inner diameter D of the vessel 1 is 0.6. The ratio of the distance h2 between the upper edge line 23 of the helical screen meshes 22 and the top of the draft tube 14 to the inner diameter D of the vessel 1 is 0.2. The ratio of the distance h3 between the bottom of the draft tube 14 and the bottom head of the vessel 1 to the inner diameter D of the vessel 1 is 0.1.

The helical surfaces of the helical screen meshes 22 are positive helical surfaces, the pore diameter of the helical screen meshes 22 is 10 mm, and the free area ratio is 82.6%.

The reaction vessel body at the corresponding portion of the gas-liquid mixing zone of the vessel 1 has a height-to-diameter ratio of 4:1. The ratio of the inner diameter of the vessel corresponding to the gas-liquid separation zone 19 to the inner diameter of the vessel corresponding to the gas-liquid mixing zone is 1.2:1. By setting a gas-liquid mixing zone with a relatively large inner diameter, it is convenient for bubbles to break and escape during the operation of the reactor.

The ratio of the area of the cross section of the annular gap-shaped riser section to the area of the cross section of the cylindrical downcomer section is 3:1, that is, the ratio of the inner diameter d of the draft tube 14 to the inner diameter D of the vessel 1 is 1:2.

The biofilm reactor of the example is an atmospheric pressure vessel and is generally operated under atmospheric pressure conditions. The biofilm reactor can be designed as a pressure vessel for specific chemical reactions and operated under permissible pressure conditions; when the reactor is designed as a pressure vessel, the carrier inlet 17 and the carrier outlet 18 are circular in shape.

### EXAMPLE 3

### 200 L Helical Bed Biofilm Reactor

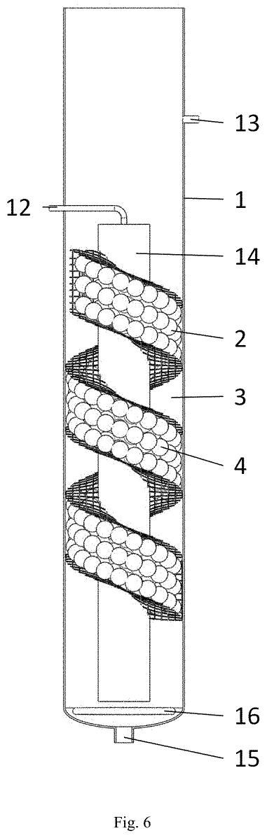

As shown in FIGS. 4-6, a helical bed biofilm reactor filled with carriers has the same basic structure as in the Example 1. The difference is that the inner diameter of the vessel corresponding to the gas-liquid separation zone 19 is the same as the inner diameter of the vessel corresponding to the gas-liquid mixing zone.

The vessel 1 has an inner diameter of 370 mm and a cylinder height of 2260 mm, and has a lower head which is an elliptic steel head and an open upper part. The draft tube 14 has an outer diameter of 160 mm, a height of 1500 mm, and a thickness of 5 mm. The bottom of the draft tube 14 is 80 mm from the lower edge of the cylindrical body of the vessel, and the draft tube 14 is supported at the bottom of the vessel by 3 legs, and is coaxially mounted with the vessel 1. Wastewater is directly introduced into the upper part of the draft tube 14 through the water inlet 12. The water outlet 13 is 350 mm from the upper edge of the cylindrical body of the vessel 1. A sludge outlet 15 is arranged at the bottom of the vessel and has a diameter of 50 mm.

The number of the carrier passage 2 is 1, and the number of the helical screen meshes 22 is 2. The height of each carrier passage 1 in the vertical direction (B shown in FIG. 4) is 200 mm. The height of each no-load passage 3 in the vertical direction (C shown in FIG. 4) is 200 mm. The pitch P of the helical screen meshes 22 is 800 mm.

The upper and lower end openings of the carrier passage 2 are intercepted by two flat screen meshes 21 in the reaction vessel, and the carrier passage 2 is filled with the carriers 4.

The distance (h1 shown in FIG. 4) between the lower edge line 24 of the helical screen meshes 22 and the bottom of the draft tube 14 is 250 mm. The distance h2 between the upper edge line 23 of the helical screen meshes 22 and the top of the draft tube is 75 mm.

The material of the helical screen meshes 22 is a polyethylene plastic flat screen mesh. The helical screen meshes 22 form a positive helical surface in the annular gap-shaped riser section, the mesh size is 8 mm×8 mm, and the wire diameter is 1.5 mm. The free area rate of the helical screen meshes 22 is 66%. The space structure of the screen mesh is fixed by a plurality of ϕ2 mm stainless steel rods horizontally penetrating through the draft tube.

The carriers 4 have a diameter of 50 mm, the mesh aperture of the peripheral carrier shells 41 is about 20 mm, and the inner core carriers 42 are honeycomb MBBR fillers.

The gas distributor 16 adopts an looped tube, and in an annular region of the looped tube, one end is connected to compressed air and the other end is closed. A plurality of downwardly venting air holes are formed in the annular pipe along the circumferential direction. The downwardly venting air holes can prevent the sludge from clogging the air holes and facilitate the cleaning and maintenance of the equipment. A main aeration tube of the looped tube has a diameter of 14 mm and a ring diameter of 300 mm, and has 20 uniformly distributed air holes with a pore diameter of 1.5 mm. The end of the looped tube is sealed with a movable nut. When the reactor is stopped, the nut can be manually removed to clean the sludge in the looped tube.

The biofilm reactor of the example is an atmospheric pressure vessel and is generally operated under normal pressure conditions. When the reactor operates, reaction liquid flows in from the water inlet 12 at a certain flow rate while flowing out from the water outlet 13 at the same flow rate, thereby maintaining the volume of the reaction liquid in the reactor constant.

### EXAMPLE 4

### Aerobic Aeration Performance of Helical Bed Biofilm Reactor

The helical bed biofilm reactor described in Example 2 was used as a device to carry out an aerobic biological treatment performance test of the wastewater, and was compared with the activated sludge process.

The inoculum sludge was derived from the secondary sedimentation vessel of a municipal wastewater treatment plant in Jiangsu Province. The concentration of the initially inoculum sludge in the reactor was 5800 mg/L mixed liquid suspended solids (MLSS). The feed liquid was artificially synthesized wastewater, and the composition were: glucose (500 mg/L), NH₄Cl (270 mg/L), KH₂PO₄ (44 mg/L), MgSO₄.5H₂O (20 mg/L), CaCl₂ (10 mg/L), FeSO₄ (2.5 mg/L), CuSO₄.5H₂O (0.39 mg/L), and MnCl₂.4H₂O (0.28 mg/L); the feed liquid was prepared with tap water, and had a pH value of 6.8-7.0.

An airlift reactor was used as a control. There was no helical screen mesh and carrier in the airlift reactor, and the size of the reaction vessel was the same as that of the helical bed biofilm reactor in the example. By the same treatment method, after aerated for 24 h, artificially synthesized wastewater was respectively added to the airlift reactor and the helical bed biofilm reactor consistented with the present disclosure. On day 6, obvious biofilms were formed on the surfaces of the carriers of the helical bed biofilm reactor, and excess suspended sludge was discharged from the reactor. Then, the wastewater feed rate was 8 L/h, the initial set value of the air flow was 8.0 L/min, and continuous operation lasted for 30 d.

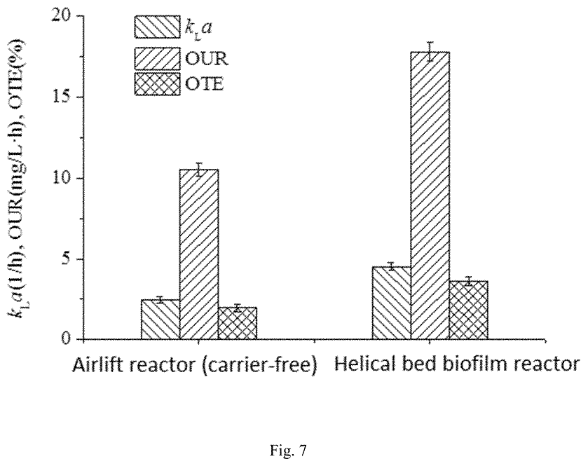

FIG. 7 was a comparison of the average data of volumetric oxygen transfer coefficient (k_{L}α), oxygen uptake rate (OUR), and oxygen transfer efficiency (OTE) after the two different reactors were stable in operation. It could be seen that the volumetric oxygen transfer coefficient k_{L}α and oxygen uptake rate OUR of the helical bed biofilm reactor were 83% and 66% higher than those of the airlift reactor, and the oxygen transfer efficiency OTE was increased by 65% compared with the airlift reactor.

What is claimed is:

1. A helical bed biofilm reactor, comprising a vessel, a draft tube, carriers and carrier passages, wherein a gas outlet is arranged at a top of the vessel; a sludge outlet is arranged at a bottom of the vessel; a water outlet and a water inlet are arranged on a side wall of the vessel; the water outlet is positioned above the water inlet; a draft tube is positioned inside the vessel and is arranged coaxially with the vessel; a height of the draft tube is smaller than a height of the vessel; an upper part of the draft tube is communicated with the water inlet; the carrier passage is positioned inside the vessel and is arranged helically along an outer side of the draft tube; the carrier passage is composed of upper and lower helical screen meshes; two side edges of each layer of the screen mesh are fixed to an inner-side wall of the vessel and an outer-side wall of the draft tube, respectively; the carrier passage is internally filled with the carriers; and a no-load passage is formed between adjacent carrier passages.

2. The helical bed biofilm reactor according to claim 1, wherein the vessel is provided with a carrier inlet and a carrier outlet; the carrier inlet is arranged at an upper part of the outer side of the vessel, and is horizontally connected with the highest point of the helical screen meshes; the carrier outlet is positioned at a lower part of the outer side of the vessel, and is connected with the lowest point of the helical screen meshes in a horizontal direction; flat screen meshes are arranged at the carrier inlet and the carrier outlet, respectively; and the flat screen meshes are connected and fixed to the two upper and lower helical screen meshes of the carrier passage.

3. The helical bed biofilm reactor according to claim 1, wherein the carrier is composed of a carrier shell and an inner core carrier; the inner core carrier is arranged inside the carrier shell and is not fixed to the carrier shell; the carrier shell is a mesh-like sphere; the inner core carrier is a carrier with brush-like protrusions on a surface or a polygonal carrier with through holes inside; and when the reactor is in operation, the inner core carrier tumbles in spherical carriers under hydraulic action.

4. The helical bed biofilm reactor according to claim 3, wherein the vessel is provided with a carrier inlet and a carrier outlet; the carrier inlet is arranged at an upper part of the outer side of the vessel, and is horizontally connected with the highest point of the helical screen meshes; the carrier outlet is positioned at a lower part of the outer side of the vessel, and is connected with the lowest point of the helical screen meshes in a horizontal direction; flat screen meshes are arranged at the carrier inlet and the carrier outlet, respectively; the flat screen meshes are connected and fixed to the two upper and lower helical screen meshes of the carrier passage; and the carrier inlet and the carrier outlet are each led out to the outer side of the vessel.

5. The helical bed biofilm reactor according to claim 3, wherein the inner core carrier has a structure selected from a group consisting of a honeycomb, a spongy, a foam-like structure and a brush-like structure.

6. The helical bed biofilm reactor according to claim 4, wherein a diameter of the carrier shell is 50-100 mm; a size of the inner core carrier is smaller than the diameter of the carrier shell and larger than a pore diameter of the carrier shell; and the inner core carrier has a structure selected from a group consisting of a honeycomb, a spongy, a foam-like structure and a brush-like structure.

7. The helical bed biofilm reactor according to claim 6, wherein the carrier inlet and the carrier outlet are each a rectangle; a height of the rectangle is equal to a vertical height of a side passage of the carriers; and the carrier inlet and the carrier outlet adopt a square vertical hanging cover hubbed flange manhole on the outer side of the vessel.

8. The helical bed biofilm reactor according to claim 6, wherein a gas distributor is arranged below the draft tube, and the gas distributor is one selected from a group consisting of: a looped tube gas distributor; a plurality of nozzles arranged in a circumferential direction; an aeration tube containing a plurality of micropores; and an aeration disc containing a plurality of micropores.

9. The helical bed biofilm reactor according to claim 8, wherein the helical screen meshes have equal pitches, and the number of the helical screen meshes is even.

10. The helical bed biofilm reactor according to claim 8, wherein a spacing between adjacent helical screen meshes is the same or different.

11. The helical bed biofilm reactor according to claim 8, wherein a helical surface of the helical screen mesh is one selected from a group consisting of: a positive helical surface; an inwardly inclined helical surface; and an outwardly inclined helical surface.

12. The helical bed biofilm reactor according to claim 8, wherein a material of the helical screen mesh is a material selected from a group consisting of plastic, nylon, composite non-metallic materials, and lightweight metal alloy materials.

13. The helical bed biofilm reactor according to claim 8, wherein a ratio of a distance between the lowest point of the helical screen meshes in a vertical direction and a bottom of the draft tube to an inner diameter of the vessel is 0.1-0.6; and a ratio of a distance between the highest point of the helical screen meshes in the vertical direction and a top of the draft tube to the inner diameter of the vessel is 0.1-0.5.

14. The helical bed biofilm reactor according to claim 8, wherein a free area ratio of the helical screen mesh is 60%-90%, and a mesh hole is smaller than a diameter of the carrier.

15. The helical bed biofilm reactor according to claim 1, wherein a height-to-diameter ratio of a cylinder part of the vessel of which an inner space is provided with a gas-liquid mixing zone is (2:1)-(6:1); an inner diameter of the gas-liquid separation zone is not less than an inner diameter of the vessel; and a ratio of a cross-sectional area of an riser section of the vessel to a cross-sectional area of a downcomer section is (1:0.3)-(1:1).

16. The helical bed biofilm reactor according to claim 6, wherein the helical screen meshes have equal pitches; the number of the helical screen meshes is even; a spacing between adjacent helical screen meshes is the same; the spacing between the adjacent helical screen meshes is 5%-50% of the pitch of the helical screen mesh; a helical surface of the helical screen mesh is one selected from a group consisting of a positive helical surface, an inwardly inclined helical surface, and an outwardly inclined helical surface; a free area ratio of the helical screen mesh is 60%-90%; a pore diameter of the helical screen mesh is 10-50 mm; and a material of the helical screen mesh is selected from a group consisting of plastic, nylon, composite non-metallic materials, and lightweight metal alloy materials.

17. The helical bed biofilm reactor according to claim 1, wherein the helical bed biofilm reactor is an atmospheric pressure vessel, or a pressure vessel.

18. A method for wastewater treatment by using the helical bed biofilm reactor according to claim 1, comprising inoculating sludge into the helical bed biofilm reactor; feeding in wastewater; and causing the helical bed biofilm reactor to operate for at least 30 days.

19. A method for wastewater treatment by using the helical bed biofilm reactor according to claim 16, comprising inoculating sludge into the helical bed biofilm reactor; feeding in wastewater; and causing the helical bed biofilm reactor to operate for at least 30 days.
